(19) United States
(12) Patent Application Publication
(10) Pub. No.: US 2026/0029937 A1
(43) Pub. Date: Jan. 29, 2026

(54) MITIGATION METHODS FOR IMPACT OF QUICK CHARGE LOSS ON READ ERRORS

(71) Applicant: Micron Technology, Inc., Boise, ID (US)

(72) Inventors: Bo Zhou, Shanghai (CN); Jianying Zhu, Shanghai (CN); Zhihui Zhang, Shanghai (CN); Xuan Liu, Shanghai (CN); Min Rui Ma, Shanghai (CN); Jiao Xiong, Shanghai (CN)

(21) Appl. No.: 19/271,633

(22) Filed: Jul. 16, 2025

Related U.S. Application Data
(60) Provisional application No. 63/676,865, filed on Jul. 29, 2024.

(51) Int. Cl. G06F 3/06

(52) U.S. Cl. CPC G06F 3/0625; G06F 3/0659; G06F 3/0673

(57) ABSTRACT

Methods, systems, and devices for mitigation methods for impact of quick charge loss (QCL) on read errors are described. The described techniques enable a memory system to determine a duration following a write operation during which a memory cell may experience QCL associated with discharge of the memory cell at a relatively high rate. The memory system may apply, to the memory cell, a voltage offset in addition to a threshold read voltage when performing read operations during the QCL duration, and may not apply the voltage offset when performing read operations following the QCL duration. Accordingly, the memory system may use a relatively higher read voltage for read operations performed during the QCL duration and a relatively lower read voltage for read operations following the QCL duration, which may result in relatively fewer errors.

### CROSS REFERENCE

The present application for patent claims priority to U.S. Patent Application No. 63/676,865 by Zhou et al., entitled “MITIGATION METHODS FOR IMPACT OF QUICK CHARGE LOSS ON READ ERRORS,” filed Jul. 29, 2024, which is assigned to the assignee hereof, and which is expressly incorporated by reference in its entirety herein.

### TECHNICAL FIELD

The following relates to one or more systems for memory, including mitigation methods for impact of quick charge loss on read errors.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports mitigation methods for impact of quick charge loss (QCL) on read errors in accordance with examples as disclosed herein.

FIG. 2 shows examples of voltage diagrams that support mitigation methods for impact of QCL on read errors in accordance with examples as disclosed herein.

FIG. 3 shows a block diagram of a memory system that supports mitigation methods for impact of QCL on read errors in accordance with examples as disclosed herein.

FIG. 4 shows a flowchart illustrating a method or methods that support mitigation methods for impact of QCL on read errors in accordance with examples as disclosed herein.

### DETAILED DESCRIPTION

In some examples, a memory system may store a logic state to a memory cell (e.g., perform a write operation) by applying a voltage pulse to the memory cell. The memory cell may store (e.g., hold, maintain) an amount of charge following the write operation. In some examples, a charge stored by the memory cell may discharge to a substrate over time. The rate of discharge may not be linear. For example, the memory cell may discharge at a relatively high rate after the program operation (e.g., for a quick charge loss (QCL) duration) before the charge stored by the memory cell plateaus for a period and then discharges at a relatively lower rate (e.g., during a slow charge loss (SCL) duration). In some examples, however, a threshold read voltage used by the memory device to read a logic state stored by a memory cell may be calibrated for the voltage stored in the memory cell during the plateau time period (and/or the SCL duration) rather than the voltage stored by the memory cell during the QCL duration. Accordingly, a read operation performed during the QCL duration using the threshold read voltage may result in an error (e.g., because the threshold read voltage may be mis calibrated relative to the charge stored in the memory cell). Further, if the memory system detects a threshold quantity of errors, the memory system may enter a read error handling operation and apply a “sticky” voltage offset (e.g., Sticky Read) when performing read operations. The memory system may continue to use the “sticky” voltage offset until a time at which another threshold quantity of errors are detected. Using the voltage offset during read operations for a period following the QCL duration may result in a relatively in more errors being detected than if a regular read voltage was used.

Accordingly, techniques described herein may enable a memory system to determine a duration (e.g., the QCL duration) following a write operation during which, if a read operation is performed for a given memory cell, a voltage offset may be applied to a memory cell along with the threshold read voltage to account for the potentially increased charge stored on the memory cell before the plateau charge duration (and/or the SCL duration). Accordingly, the memory system may use a relatively higher read voltage for read operations performed during the QCL duration and a relatively lower read voltage (e.g., the threshold read voltage) for read operations following the QCL duration, which may reduce errors (e.g., and reduce a likelihood that the device enables read error handling and the sticky read offset in accordance with temporary charge levels). The read voltage that is applied to the memory cells during the QCL duration may be a sum of a default read voltage for the memory cell and the voltage offset. The memory system may therefore perform read operations during the QCL duration with relatively fewer errors, which may decrease latency and power consumption of the memory system.

In addition to applicability in memory systems as described herein, techniques for mitigating an impact of QCL on read voltage errors may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by reducing a quantity of errors related to performing read commands that may occur as a result of QCL, which may improve response times and user experience, among other benefits.

In addition to applicability in memory systems as described herein, techniques for mitigating an impact of QCL on read voltage errors may be generally implemented to improve the sustainability of various electronic devices and systems. As the use of electronic devices has become even more widespread, the amount of energy used and harmful emissions associated with production of electronic devices and device operation has increased. Further, the amount of waste (e.g., electronic waste) associated with disposal of electronic devices may also pose environmental concerns. Implementing the techniques described herein may improve the impact related to electronic devices by reducing a quantity of unsuccessful read commands that may occur as a result of QCL, which may reduce power consumption of electronic devices and extend the life of electronic devices, thereby reducing electronic waste, among other benefits.

Features of the disclosure are illustrated and described in the context of systems, devices, and circuits. Features of the disclosure are further illustrated and described in the context of voltage diagrams and flowcharts.

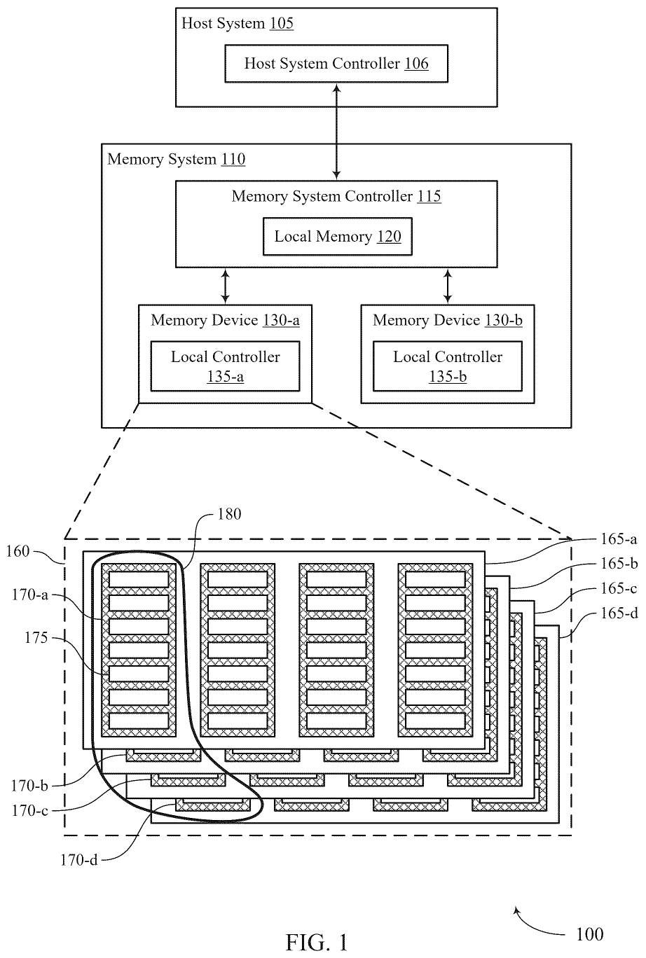

FIG. 1 shows an example of a system 100 that supports mitigation methods for impact of QCL on read errors in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IOT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some examples of the system 100, the memory system 110 may determine (e.g., identify, estimate, measure) a QCL duration following a write operation during which a memory cell may experience QCL (e.g., a relatively quick rate of charge loss or discharge from the memory cell to a substrate or other portion of the memory system 110). The memory system 110 may perform a read operation during the QCL duration (e.g., in response to receiving a command from a host system 105, as part of a scan operation, as part of an error handling operation, or the like). The memory system 110 may apply a voltage offset to a threshold read voltage used to read a logic state from the memory cell in accordance with performing the read operation during the QCL duration.

The system 100 may include any quantity of non-transitory computer readable media that support mitigation methods for impact of QCL on read errors. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

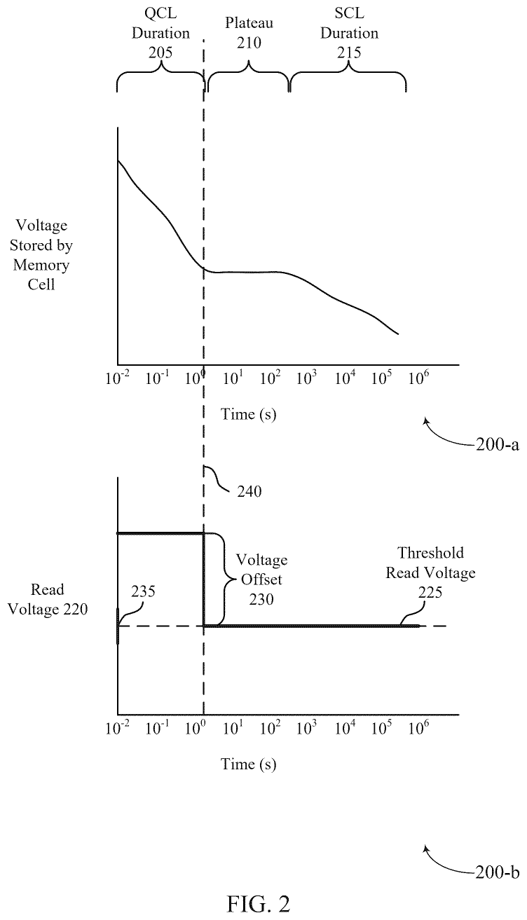

FIG. 2 shows examples of a voltage diagram 200-a and a voltage diagram 200-b that support mitigation methods for impact of QCL on read errors in accordance with examples as disclosed herein. The voltage diagram 200-a and the voltage diagram 200-b may implement or may be implemented by aspects of the system 100. For example, the voltage diagram 200-a and the voltage diagram 200-b may be implemented in the memory system 110 as described with reference to FIG. 1. The techniques described in the context of the voltage diagram 200-a and the voltage diagram 200-b may enable the memory system 110 to apply a voltage offset 230 to a threshold read voltage 225 used for read commands at the memory system to mitigate an effect of QCL and thereby reduce errors associated with performing read commands.

In some examples, a memory system may perform a write operation to store a logic state in one or more memory cells of the memory system. The logic state may be associated with a threshold read voltage 225 which the memory system may apply to read the logic state from the memory cell as part of a read operation. In some examples, storing the logic state to the memory cell may include storing, in the memory cell, an amount of voltage that is associated with the logic state (e.g., above the threshold read voltage for the logic state). As illustrated with reference to the voltage diagram 200-a, the amount of voltage stored by the memory cell may change (e.g., decrease) during a time following the write operation due to charge stored by a storage layer of the memory cell discharging to a substrate of the memory system (e.g., ground, or some other region). For example, during a QCL duration 205, the voltage stored by the memory cell may decrease at a relatively faster rate than during other durations over which the memory cell stores the logic state. During a plateau duration 210, the voltage stored by the memory cell may remain relatively constant over time. For example, a rate of discharge during the plateau duration 210 may be zero or relatively small. During a SCL duration 215, voltage stored by the memory cell may decrease at a relatively slower rate than the rate of decrease associated with the QCL duration 205. In some examples, the memory cell may not experience the plateau duration 210. For example, the memory cell may experience charge loss with a rate of decrease associated with a QCL duration 205 immediately followed by a SCL duration 215.

As illustrated with reference to the voltage diagram 200-a, the x-axis may represent units of time according to a logarithmic scale. Accordingly, a length of the QCL duration 205 (e.g., between 1 microsecond (us) and 1 second(s), or some other length) may be relatively shorter than a length of the plateau duration (e.g., between 0-100 s, or some other length) and a length of the SCL duration 215 (e.g., 100 s or greater, or some other length). The QCL duration 205 for which the memory cell discharges voltage relatively quickly is thereby a relatively short period of time. The voltage diagram 200-a illustrated with reference to FIG. 2 is an illustrative example, and one or more memory cells may experience charge loss according to another voltage diagram 200. For example, one or more memory cells may experience charge loss according to another time scale (e.g., a time scale different from the logarithmic scale illustrated with reference to the voltage diagram 200-a).

In some examples, a read error handling (REH) flow for a memory system (e.g., an MNAND system or some other system) may be designed to handle errors detected during the plateau duration 210, during the SCL duration 215 (e.g., SCL charge loss), or errors due to temperature-induced threshold read voltage misplacement, or any combination thereof. For example, a threshold read voltage 225 used by the memory system to perform read operations of the memory cell may be calibrated for a voltage stored by the memory cell during the plateau duration 210 (e.g., or the SCL duration 215, in examples in which the memory cell may not experience the plateau duration 210). Accordingly, during the QCL duration 205, read operations by the memory system may incur a relatively large quantity of errors because the read voltage for reading the memory cells may be calibrated for the plateau duration 210 or the SCL duration 215 and the charge stored in the memory cells may be greater during the QCL duration 205 than the plateau duration 210 or the SCL duration 215.

Additionally, or alternatively, read error recovery statistics (ERS) associated with the memory system may indicate that the memory system detects a relatively larger quantity of errors during and following the QCL duration 205 due to REH operations (e.g., read last, Sticky Read) performed during the QCL duration 205. For example, during an immediate read scan, an auto read calibration (ARC) step may be triggered with a relatively large offset (e.g., a maximum positive offset). Further, the memory system may enable a sticky read offset in response to detecting a threshold quantity of read errors. While the sticky read offset is enabled, the memory system may perform read operations using a voltage offset 230 applied to the threshold read voltage 225. That is, the memory system may use a relatively larger read voltage for read operations while the sticky read offset is enabled. The memory system may disable the sticky read offset (e.g., and therefore perform read operations using the threshold read voltage 225 without the voltage offset 230) in response to detecting a second threshold quantity of read errors. Accordingly, if the sticky read offset is enabled during the QCL duration 205 and disabled during the plateau duration 210 or SCL duration 215, the memory system may detect both of the first threshold quantity of read errors and the second threshold quantity of read errors, which may result in a relatively high normal block trigger rate (e.g., a relatively high quantity of errors detected in response to normal read operations). That is, the sticky read offset may maintain a relatively large and inaccurate read voltage during the plateau duration 210, the SCL duration 215, or both, which may continue to produce errors.

In some examples, the memory system may perform read operations during the QCL duration 205 in response to receiving a request from a host system, as part of an immediate read scan or read back (e.g., a scan operation performed following a write operation to increase a reliability of data written from a source block to a destination block), or as part of another read operation (e.g., a normal block read). For example, an immediate read scan operation may occur during a time following the write operation that falls within the QCL duration 205 (e.g., 180 milliseconds (ms) after the write operation). In some examples, a time following the write operation at which the memory system may read the logic state stored in the memory cell may decrease further due to a relatively smaller NAND read window budget margin, a relatively shorter programming time (e.g., Tprog), and the like.

To reduce a quantity of errors detected during the QCL duration 205, as illustrated with reference to the voltage diagram 200-b, the memory system may apply a voltage offset 230 to the threshold read voltage 225 for read operations performed during the QCL duration 205 (e.g., a threshold duration). For example, if the memory system determines to (e.g., is scheduled to or otherwise triggered to) perform a read operation (e.g., as part of an immediate scan, in response to a read command from a host device, as part of a periodic scan, as part of a task triggered scan), the memory system may determine whether the read operation is during the QCL duration 205 (e.g., within a threshold duration after a program time 235 at which the memory cell was programmed). In response to determining that the read operation is to be performed during the QCL duration 205 (e.g., prior to a threshold time 240), the memory system may determine to apply the voltage offset 230 to the threshold read voltage 225.

The memory system may therefore apply the voltage offset 230 in addition to the threshold read voltage 225 for read operations performed at a second time that is during the QCL duration 205 (e.g., less than a threshold duration after the program time 235) and may refrain from applying the voltage offset 230 for read operations performed at a second time that is during a time period following the QCL duration 205 (e.g., after the threshold time 240). That is, the memory system may apply a relatively larger read voltage 220 for read operations during the QCL duration 205 than for read operations following the QCL duration 205. Such techniques may decrease a quantity of errors detected by the memory system during the QCL duration 205 and following the QCL duration 205 because the voltage offset 230 may account for a higher charge in the memory cell during the QCL duration 205.

In some examples, the memory system may define a timer to determine the threshold duration during which the memory system may apply the voltage offset 230. For example, the memory system may initiate a timer in response to performing the write operation at the program time 235 (e.g., a first time). A duration of the timer may be configured or calibrated at the memory system based on a duration associated with QCL. If the memory system determines to perform a read operation (e.g., as part of an immediate scan, in response to a read command from a host device, as part of a periodic scan, as part of a task triggered scan), the memory system may determine whether the timer has expired. If the timer has not expired, the memory system may apply the voltage offset 230 when performing the read operation. If the timer has expired, the memory system may not apply the voltage offset 230 when performing the read operation. In some examples, the memory system may refrain from using one or more other REH techniques such as applying an additional voltage offset (e.g., due to enabling the sticky read offset) during the QCL duration 205 (e.g., while the timer is active). In some examples, the timer may be initiated at a page level or at a word line level (e.g., for a page of memory cells programmed at the program time 235, a word line of memory cells programmed at the program time 235).

In some examples, the memory system may perform a calibration to determine the length of the QCL duration 205 (e.g., 60 s or some other duration) and/or to determine the voltage offset 230 (e.g., 150 millivolts (mV) or some other value). For example, the memory system may determine a period of time following a write operation during which the rate of charge loss is relatively high and during which the memory system may apply the voltage offset 230. Additionally, or alternatively, the memory system may determine a size of the voltage offset 230 in accordance with a characterization of the QCL duration 205. For example, a size of the voltage offset 230 may be in accordance with one or more charges measured during the QCL duration 205 in one or more testing or calibration operations. In some examples, the memory system may perform the calibration during manufacture of the memory system. For example, a manufacturer may calibrate one or more memory systems before mass manufacture and/or deployment of the memory systems. In some examples, the QCL duration 205, the voltage offset 230, or both may be disclosed in a product data sheet associated with the memory system. Additionally, or alternatively, the one or more calibration operations may be performed during operation of the memory system (e.g., following manufacturing). In some examples, the calibration may be performed by another device (e.g., a host system) and indicated (e.g., configured) to the memory system. In some examples, the QCL duration 205 (e.g., and/or the length of the timer) and the voltage offset 230 may be tuned for the memory system during development (e.g., and may not change over time).

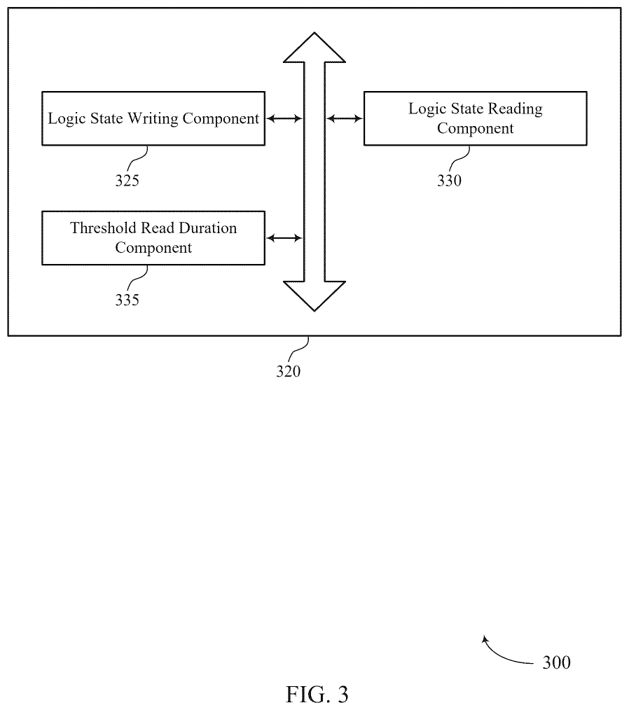

FIG. 3 shows a block diagram 300 of a memory system 320 that supports mitigation methods for impact of QCL on read errors in accordance with examples as disclosed herein. The memory system 320 may be an example of aspects of a memory system as described with reference to FIGS. 1 through 2. The memory system 320, or various components thereof, may be an example of means for performing various aspects of mitigation methods for impact of QCL on read errors as described herein. For example, the memory system 320 may include a logic state writing component 325, a logic state reading component 330, a threshold read duration component 335, or any combination thereof. Each of these components, or components of subcomponents thereof (e.g., one or more processors, one or more memories), may communicate, directly or indirectly, with one another (e.g., via one or more buses).

The logic state writing component 325 may be configured as or otherwise support a means for writing, at a first time, a logic state to a memory cell of a memory system, the logic state associated with a threshold read voltage for reads of the logic state. The logic state reading component 330 may be configured as or otherwise support a means for reading, at a second time, the logic state from the memory cell using a first read voltage, where the first read voltage includes a sum of the threshold read voltage associated with the logic state and a voltage offset, where the voltage offset is in accordance with the second time being less than a threshold duration after the first time.

In some examples, the threshold read duration component 335 may be configured as or otherwise support a means for determining, in response to detecting a read operation for the memory cell at the second time, whether a difference between the first time and the second time is less than the threshold duration, where reading, at the second time, the logic state using the sum of the threshold read voltage and the voltage offset is in accordance with determining that the difference is less than the threshold duration.

In some examples, the threshold read duration component 335 may be configured as or otherwise support a means for initiating a timer associated with the threshold duration in response to writing the logic state to the memory cell. In some examples, the threshold read duration component 335 may be configured as or otherwise support a means for determining whether the timer has expired, where reading, at the second time, the logic state using the sum of the threshold read voltage and the voltage offset is in accordance with determining that the timer has not expired at the second time.

In some examples, the logic state reading component 330 may be configured as or otherwise support a means for reading, at a third time, the logic state from the memory cell using the threshold read voltage associated with the logic state in accordance with the third time being more than the threshold duration after the first time.

In some examples, the threshold read voltage is associated with reads to the memory cell during a time period that is more than the threshold duration after the first time.

In some examples, a first voltage stored by the memory cell between the first time and a third time at which the threshold duration expires is greater than a second voltage stored by the memory cell during the time period. In some examples, the voltage offset is calibrated in accordance with the first voltage.

In some examples, the logic state reading component 330 may be configured as or otherwise support a means for receiving a read command from a host system, where reading the logic state is in response to the read command.

In some examples, the logic state reading component 330 may be configured as or otherwise support a means for performing a scan operation or an error handling operation associated with the memory cell, where reading the logic state is in accordance with the scan operation or the error handling operation.

In some examples, the scan operation includes a periodic scan operation or a task triggered scan operation.

In some examples, the threshold duration is associated with a QCL period for the memory cell.

In some examples, the described functionality of the memory system 320, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 320, or various components thereof, may be implemented at least in part by instructions (e.g., stored in memory, non-transitory computer-readable medium) executable by such at least one processor.

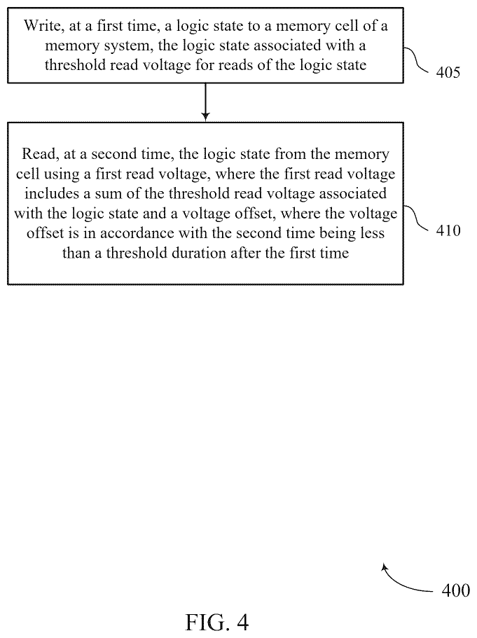

FIG. 4 shows a flowchart illustrating a method 400 that supports mitigation methods for impact of QCL on read errors in accordance with examples as disclosed herein. The operations of method 400 may be implemented by a memory system or its components as described herein. For example, the operations of method 400 may be performed by a memory system as described with reference to FIGS. 1 through 3. In some examples, a memory system may execute a set of instructions to control the functional elements of the device to perform the described functions. Additionally, or alternatively, the memory system may perform aspects of the described functions using special-purpose hardware.

At 405, the method may include writing, at a first time, a logic state to a memory cell of a memory system, the logic state associated with a threshold read voltage for reads of the logic state. In some examples, aspects of the operations of 405 may be performed by a logic state writing component 325 as described with reference to FIG. 3.

At 410, the method may include reading, at a second time, the logic state from the memory cell using a first read voltage, where the first read voltage includes a sum of the threshold read voltage associated with the logic state and a voltage offset, where the voltage offset is in accordance with the second time being less than a threshold duration after the first time. In some examples, aspects of the operations of 410 may be performed by a logic state reading component 330 as described with reference to FIG. 3.

In some examples, an apparatus as described herein may perform a method or methods, such as the method 400. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for writing, at a first time, a logic state to a memory cell of a memory system, the logic state associated with a threshold read voltage for reads of the logic state and reading, at a second time, the logic state from the memory cell using a first read voltage, where the first read voltage includes a sum of the threshold read voltage associated with the logic state and a voltage offset, where the voltage offset is in accordance with the second time being less than a threshold duration after the first time.
Aspect 2: The method, apparatus, or non-transitory computer-readable medium of aspect 1, further including operations, features, circuitry, logic, means, or instructions, or any combination thereof for determining, in response to detecting a read operation for the memory cell at the second time, whether a difference between the first time and the second time is less than the threshold duration, where reading, at the second time, the logic state using the sum of the threshold read voltage and the voltage offset is in accordance with determining that the difference is less than the threshold duration.
Aspect 3: The method, apparatus, or non-transitory computer-readable medium of any of aspects 1 through 2, further including operations, features, circuitry, logic, means, or instructions, or any combination thereof for initiating a timer associated with the threshold duration in response to writing the logic state to the memory cell and determining whether the timer has expired, where reading, at the second time, the logic state using the sum of the threshold read voltage and the voltage offset is in accordance with determining that the timer has not expired at the second time.
Aspect 4: The method, apparatus, or non-transitory computer-readable medium of any of aspects 1 through 3, further including operations, features, circuitry, logic, means, or instructions, or any combination thereof for reading, at a third time, the logic state from the memory cell using the threshold read voltage associated with the logic state in accordance with the third time being more than the threshold duration after the first time.
Aspect 5: The method, apparatus, or non-transitory computer-readable medium of any of aspects 1 through 4, where the threshold read voltage is associated with reads to the memory cell during a time period that is more than the threshold duration after the first time.
Aspect 6: The method, apparatus, or non-transitory computer-readable medium of aspect 5, where a first voltage stored by the memory cell between the first time and a third time at which the threshold duration expires is greater than a second voltage stored by the memory cell during the time period and the voltage offset is calibrated in accordance with the first voltage.
Aspect 7: The method, apparatus, or non-transitory computer-readable medium of any of aspects 1 through 6, further including operations, features, circuitry, logic, means, or instructions, or any combination thereof for receiving a read command from a host system, where reading the logic state is in response to the read command.
Aspect 8: The method, apparatus, or non-transitory computer-readable medium of any of aspects 1 through 7, further including operations, features, circuitry, logic, means, or instructions, or any combination thereof for performing a scan operation or an error handling operation associated with the memory cell, where reading the logic state is in accordance with the scan operation or the error handling operation.
Aspect 9: The method, apparatus, or non-transitory computer-readable medium of aspect 8, where the scan operation includes a periodic scan operation or a task triggered scan operation.
Aspect 10: The method, apparatus, or non-transitory computer-readable medium of any of aspects 1 through 9, where the threshold duration is associated with a QCL period for the memory cell.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit according to the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
processing circuitry associated with one or more memory devices and configured to cause the apparatus to:
write, at a first time, a logic state to a memory cell of a memory system, the logic state associated with a threshold read voltage for reads of the logic state; and
read, at a second time, the logic state from the memory cell using a first read voltage, wherein the first read voltage comprises a sum of the threshold read voltage associated with the logic state and a voltage offset, wherein the voltage offset is in accordance with the second time being less than a threshold duration after the first time.

2. The apparatus of claim 1, wherein the processing circuitry is further configured to cause the apparatus to:
determine, in response to detecting a read operation for the memory cell at the second time, whether a difference between the first time and the second time is less than the threshold duration, wherein reading, at the second time, the logic state using the sum of the threshold read voltage and the voltage offset is in accordance with determining that the difference is less than the threshold duration.

3. The apparatus of claim 1, wherein the processing circuitry is further configured to cause the apparatus to:
initiate a timer associated with the threshold duration in response to writing the logic state to the memory cell; and
determine whether the timer has expired, wherein reading, at the second time, the logic state using the sum of the threshold read voltage and the voltage offset is in accordance with determining that the timer has not expired at the second time.

4. The apparatus of claim 1, wherein the processing circuitry is further configured to cause the apparatus to:
read, at a third time, the logic state from the memory cell using the threshold read voltage associated with the logic state in accordance with the third time being more than the threshold duration after the first time.

5. The apparatus of claim 1, wherein the threshold read voltage is associated with reads to the memory cell during a time period that is more than the threshold duration after the first time.

6. The apparatus of claim 5, wherein a first voltage stored by the memory cell between the first time and a third time at which the threshold duration expires is greater than a second voltage stored by the memory cell during the time period, and wherein the voltage offset is calibrated in accordance with the first voltage.

7. The apparatus of claim 1, wherein the processing circuitry is further configured to cause the apparatus to:
receive a read command from a host system, wherein reading the logic state is in response to the read command.

8. The apparatus of claim 1, wherein the processing circuitry is further configured to cause the apparatus to:
perform a scan operation or an error handling operation associated with the memory cell, wherein reading the logic state is in accordance with the scan operation or the error handling operation.

9. The apparatus of claim 8, wherein the scan operation comprises a periodic scan operation or a task triggered scan operation.

10. The apparatus of claim 1, wherein the threshold duration is associated with a quick charge loss period for the memory cell.

11. A non-transitory computer-readable medium storing code, the code comprising instructions executable by one or more processors to:
write, at a first time, a logic state to a memory cell of a memory system, the logic state associated with a threshold read voltage for reads of the logic state; and
read, at a second time, the logic state from the memory cell using a first read voltage, wherein the first read voltage comprises a sum of the threshold read voltage associated with the logic state and a voltage offset, wherein the voltage offset is in accordance with the second time being less than a threshold duration after the first time.

12. The non-transitory computer-readable medium of claim 11, wherein the instructions are further executable by the one or more processors to:
determine, in response to detecting a read operation for the memory cell at the second time, whether a difference between the first time and the second time is less than the threshold duration, wherein reading, at the second time, the logic state using the sum of the threshold read voltage and the voltage offset is in accordance with determining that the difference is less than the threshold duration.

13. The non-transitory computer-readable medium of claim 11, wherein the instructions are further executable by the one or more processors to:
initiate a timer associated with the threshold duration in response to writing the logic state to the memory cell; and
determine whether the timer has expired, wherein reading, at the second time, the logic state using the sum of the threshold read voltage and the voltage offset is in accordance with determining that the timer has not expired at the second time.

14. The non-transitory computer-readable medium of claim 11, wherein the instructions are further executable by the one or more processors to:
read, at a third time, the logic state from the memory cell using the threshold read voltage associated with the logic state in accordance with the third time being more than the threshold duration after the first time.

15. The non-transitory computer-readable medium of claim 11, wherein the threshold read voltage is associated with reads to the memory cell during a time period that is more than the threshold duration after the first time.

16. The non-transitory computer-readable medium of claim 15, wherein a first voltage stored by the memory cell between the first time and a third time at which the threshold duration expires is greater than a second voltage stored by the memory cell during the time period, and wherein the voltage offset is calibrated in accordance with the first voltage.

17. The non-transitory computer-readable medium of claim 11, wherein the instructions are further executable by the one or more processors to:
receive a read command from a host system, wherein reading the logic state is in response to the read command.

18. The non-transitory computer-readable medium of claim 11, wherein the instructions are further executable by the one or more processors to:
perform a scan operation or an error handling operation associated with the memory cell, wherein reading the logic state is in accordance with the scan operation or the error handling operation.

19. The non-transitory computer-readable medium of claim 18, wherein the scan operation comprises a periodic scan operation or a task triggered scan operation.

20. The non-transitory computer-readable medium of claim 11, wherein the threshold duration is associated with a quick charge loss period for the memory cell.

21. A method, comprising:
writing, at a first time, a logic state to a memory cell of a memory system, the logic state associated with a threshold read voltage for reads of the logic state; and
reading, at a second time, the logic state from the memory cell using a first read voltage, wherein the first read voltage comprises a sum of the threshold read voltage associated with the logic state and a voltage offset, wherein the voltage offset is in accordance with the second time being less than a threshold duration after the first time.

22. The method of claim 21, further comprising:
determining, in response to detecting a read operation for the memory cell at the second time, whether a difference between the first time and the second time is less than the threshold duration, wherein reading, at the second time, the logic state using the sum of the threshold read voltage and the voltage offset is in accordance with determining that the difference is less than the threshold duration.

23. The method of claim 21, further comprising:
initiating a timer associated with the threshold duration in response to writing the logic state to the memory cell; and
determining whether the timer has expired, wherein reading, at the second time, the logic state using the sum of the threshold read voltage and the voltage offset is in accordance with determining that the timer has not expired at the second time.

24. The method of claim 21, further comprising:
reading, at a third time, the logic state from the memory cell using the threshold read voltage associated with the logic state in accordance with the third time being more than the threshold duration after the first time.

25. The method of claim 21, wherein the threshold read voltage is associated with reads to the memory cell during time period that is more than the threshold duration after the first time.
